(19) United States
(12) Patent Application Publication
(10) Pub. No.: US 2015/0260973 A1
(43) Pub. Date: Sep. 17, 2015

(54) FOCUS DETERMINATION APPARATUS, FOCUS DETERMINATION METHOD, AND IMAGING APPARATUS

(71) Applicant: CANON KABUSHIKI KAISHA, Tokyo (JP)

(72) Inventor: Minoru Kusakabe, Yokohama-shi (JP)

(21) Appl. No.: 14/636,373

(22) Filed: Mar. 3, 2015

(30) Foreign Application Priority Data
Mar. 17, 2014 (JP) 2014-053655
Dec. 24, 2014 (JP) 2014-260918

(51) Int. Cl. G02B 21/24; G02B 21/36

(52) U.S. Cl. CPC G02B 21/244; G02B 21/36

(57) ABSTRACT

A write region is detected based on an image of an object, when performing split imaging of the object using a microscope. When a certain region includes a feature region that is a region in which an image feature related to a color or an image feature related to smoothness of a change in a pixel value satisfies a predetermined condition, and when the feature region has an area equal to or greater than a predetermined value in the image, the region is determined to be a write region. For an imaging position within the write region, an in-focus position of the imaging position is determined based on a value of an in-focus position of a position different from the imaging position.

### BACKGROUND OF THE INVENTION

1. Field of the Invention

The present invention relates to a focus determination apparatus and a method thereof for use in an imaging apparatus. Particularly, the present invention relates to a focus determination apparatus and a method thereof for use in an imaging apparatus using a microscope.

2. Description of the Related Art

In the past, when capturing an image of an object, a foreign matter other than the object often enters the optical system between the object and the image sensor, causing undesirable impacts on the focusing operation. As a way to cope with this problem, there is disclosed a method for focusing while reducing or eliminating the impacts of foreign matters (see Japanese Patent Application Publication No. 2010-14981). Japanese Patent Application Publication No. 2010-14981 discloses a method for estimating the level of an impact on the focusing operation based on the previously detected size of a foreign matter and then changing the position to focus on an object based on the size of the foreign matter.

An imaging apparatus is, for example, an imaging apparatus installed in a microscope, and a slide (also called “preparation”) is typically used as an observation target. Since the microscopic field is generally narrower than an observation target, the positions that need attention are recorded on a slide. For instance, in some cases the positions that need to be observed are marked by hand with a permanent marker or the like on a cover glass placed on an upper surface of the slide. Writing (marking) on a slide in this manner is another factor that causes undesirable impacts on the focusing operation.

According to Japanese Patent Application Publication No. 2010-14981, image signals for detecting foreign matters such as dirt adhering to the optical system are used in order to detect the positions or sizes of the foreign matters. At the time of focus determination, whether to use a region containing foreign matters or not is determined, so that a focus is put not on the foreign matters but on the object.

The method disclosed in Japanese Patent Application Publication No. 2010-14981, however, needs to execute a foreign matter detection operation as a preliminary operation of the imaging apparatus prior to actually capturing an image of the object. Furthermore, the foreign matters aimed by the method described in Japanese Patent Application Publication No. 2010-14981 are not the ones that vary depending on the objects. Therefore, even when the method described in Japanese Patent Application Publication No. 2010-14981 is employed to capture an image of each object (a slide or the like) with marks thereon, it is difficult to avoid the risk of focusing on the marks that vary depending on the objects.

### SUMMARY OF THE INVENTION

The present invention was contrived in view of the foregoing problems, and provides a technique that enables prevention of erroneous focusing caused by a mark written on an object.

The present invention in its first aspect provides a focus determination method for determining an in-focus position in an optical axis direction at each of imaging positions when performing split imaging of an object using a microscope, the focus determination method comprising: a write region detection step of detecting a write region in which writing is performed on the object, based on an image obtained by imaging the object; and an in-focus position determination step of determining an in-focus position of each of the imaging positions, wherein when a certain region includes a feature region that is a region in which an image feature related to a color or an image feature related to smoothness of a change in a pixel value satisfies a predetermined condition, and when the feature region has an area equal to or greater than a predetermined value in the image, the region is determined to be a write region in the write region detection step, and for an imaging position within the write region, an in-focus position of the imaging position is determined based on a value of an in-focus position of a position different from the imaging position, in the in-focus position determination step.

The present invention in its second aspect provides a focus determination apparatus for determining an in-focus position in an optical axis direction at each of imaging positions when performing split imaging of an object using a microscope, the focus determination apparatus comprising: a write region detection portion configured to detect a write region in which writing is performed on the object, based on an image obtained by imaging the object; and an in-focus position determination portion configured to determine an in-focus position of each of the imaging positions, wherein when a certain region includes a feature region that is a region in which an image feature related to a color or an image feature related to smoothness of a change in a pixel value satisfies a predetermined condition, and when the feature region has an area equal to or greater than a predetermined value in the image, the write region detection portion determines that the region is a write region, and for an imaging position within the write region, the in-focus position determination portion determines an in-focus position of the imaging position based on a value of an in-focus position of a position different from the imaging position.

The present invention in its third aspect provides an imaging apparatus having a function for performing split imaging of an object using a microscope, the imaging apparatus comprising: the focus determination apparatus according to the present invention which determines an in-focus position in an optical axis direction at each of imaging positions when performing split imaging of an object; an imaging position moving portion configured to move a position of the object in the optical axis direction in accordance with the in-focus position determined by the focus determination apparatus; and an output image capturing portion configured to acquire an output image by imaging the object that is aligned by the imaging position moving portion.

The present invention in its fourth aspect provides a non-transitory computer readable storage medium storing a program for causing a computer to execute each of the steps of the focus determination method according to the present invention.

The present invention can prevent erroneous focusing caused by a mark written on an object.

Further features of the present invention will become apparent from the following description of exemplary embodiments with reference to the attached drawings.

### BRIEF DESCRIPTION OF THE DRAWINGS

FIG. 1 is a configuration diagram of a microscopic apparatus;

FIG. 2 is a configuration diagram of a controller;

FIGS. 3A and 3B each show an example of a slide;

FIG. 4 is a functional block diagram of a focus determination method according to a first embodiment;

FIG. 5 is a flowchart showing a flow of operations of the focus determination method according to the first embodiment;

FIG. 6 is a flowchart showing the details of a write region detection process according to the first embodiment;

FIG. 7 shows an example of a target region on a slide according to a second embodiment; and

FIG. 8 shows an example of a target region on a slide according to a third embodiment.

### DESCRIPTION OF THE EMBODIMENTS

The present invention relates to a focus determination apparatus and method for preventing a mark written on an object from being focused by mistake. This technique may be installed in an imaging apparatus as an underlying technology of an automatic focusing function or may be installed in an image processing apparatus for extracting an in-focus image from a group of a plurality of layers of images (referred to as “Z-stack images” or “focus bracket images”) which are captured, with the focusing positions being changed in an optical axis direction. A specific example of application is described hereinafter with the assumption that a slide is used as an object, and a microscope or the like for capturing a still image at high resolution is used as an imaging apparatus.

### First Embodiment

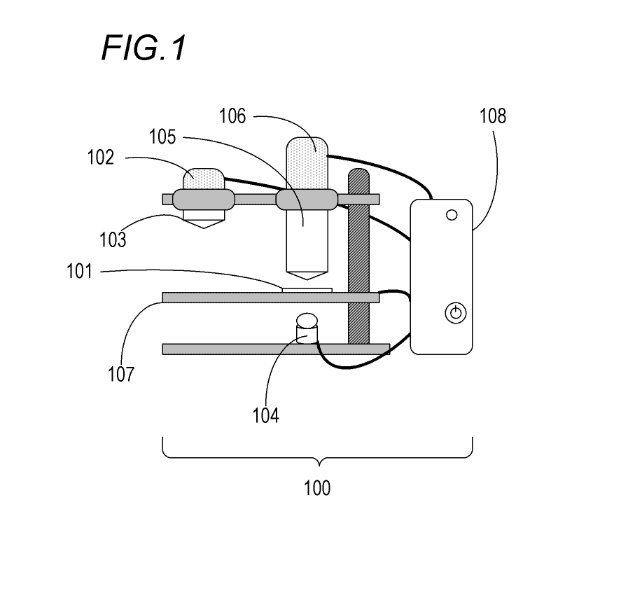

FIG. 1 shows a configuration of an apparatus according to a first embodiment of the present invention. In FIG. 1, reference numeral 100 represents a microscopic apparatus capable of capturing still images. Reference numeral 101 represents an object (an imaging and observation target). In the present embodiment, a slide 101 with a transparent matter thereon is used as the object. Reference numeral 102 is a whole image capturing unit for capturing an image of the entire object. The whole image capturing unit 102 captures an image of the object with a low-magnification whole image objective lens 103. Reference numeral 104 represents a light source and reference numeral 105 an objective lens. Light from the light source 104 is fed to the objective lens 105 through the slide 101. The objective lens 105 has a magnification higher than that of the whole image objective lens 103 and cannot contain the entire slide 101 into its field of view. Reference numeral 106 represents an imaging unit for capturing an image of the object through the objective lens 105. Reference numeral 107 represents a stage for placing the slide 101 thereon, the stage being capable of moving in a plane (referred to as “X-Y plane”) perpendicular to an optical axis direction (referred to as “Z direction,” hereinafter) of the objective lens 105. The stage 107 is also capable of moving with respect to the optical axis direction at the time of imaging and of changing a focusing position with respect to a direction of the thickness of the object. Reference numeral 108 represents a controller for controlling the operations of the whole image capturing unit 102, the light source 104, the imaging unit 106, the stage 107 and the like. Note that the objective lens 105 is replaceable with a plurality of lenses of different magnifications or may be equipped with a zoom mechanism. In this case, the controller 108 may switch the lenses or control the zoom mechanism.

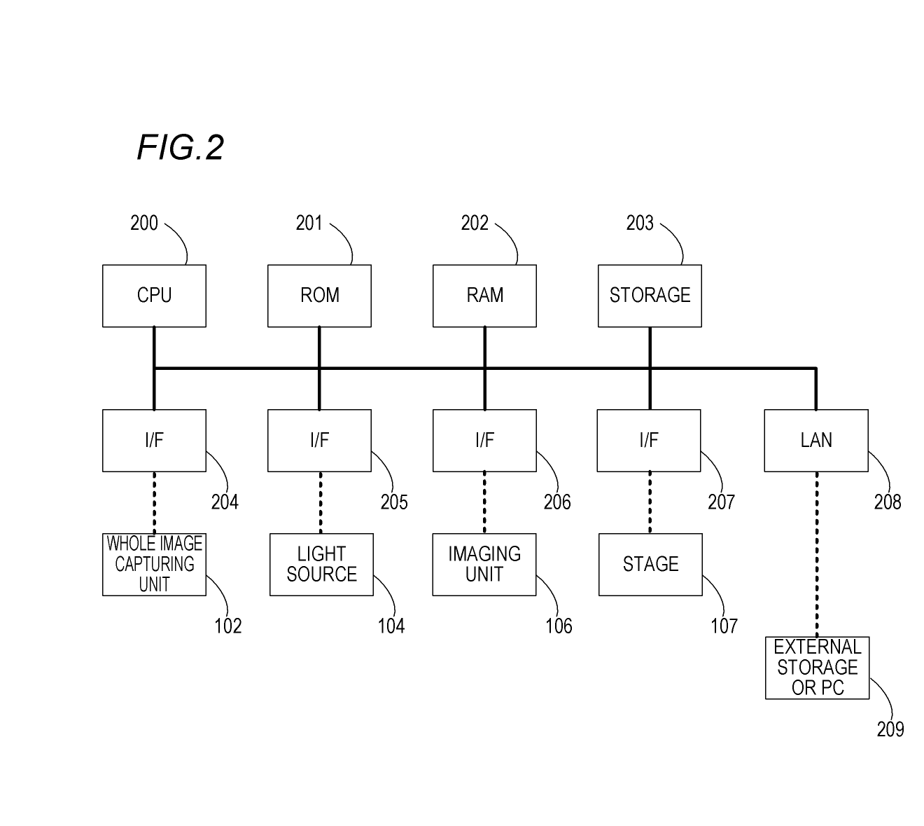

FIG. 2 shows the relationship between an internal configuration of the controller 108 executing the focus determination method according to the present embodiment and various devices configuring the microscopic apparatus 100. Reference numeral 200 represents a CPU for executing arithmetic operations required for processes. Reference numeral 201 is a ROM for storing programs and data and allows the stored programs and data to be read. Reference numeral 202 represents a RAM which allows the programs and the data required for processes to be read and written. Reference numeral 203 represents a storage that allows the programs, image data and the like to be read and written and is configured with an HDD, SSD or the like. Reference numerals 204 to 207 represent interfaces that are connected to the whole image capturing unit 102, the light source 104, the imaging unit 106, and the stage 107, respectively. Reference numeral 208 represents a LAN interface for transmitting and receiving data when the controller 108 communicates with an external storage, not shown, which is connected to a network or with a PC 209. The processes by the microscopic apparatus 100, described hereinafter, are realized by programs executed by the CPU 200. Note that the controller 108 may be installed as an embedded computer in the microscopic apparatus 100 or realized using a multipurpose computer.

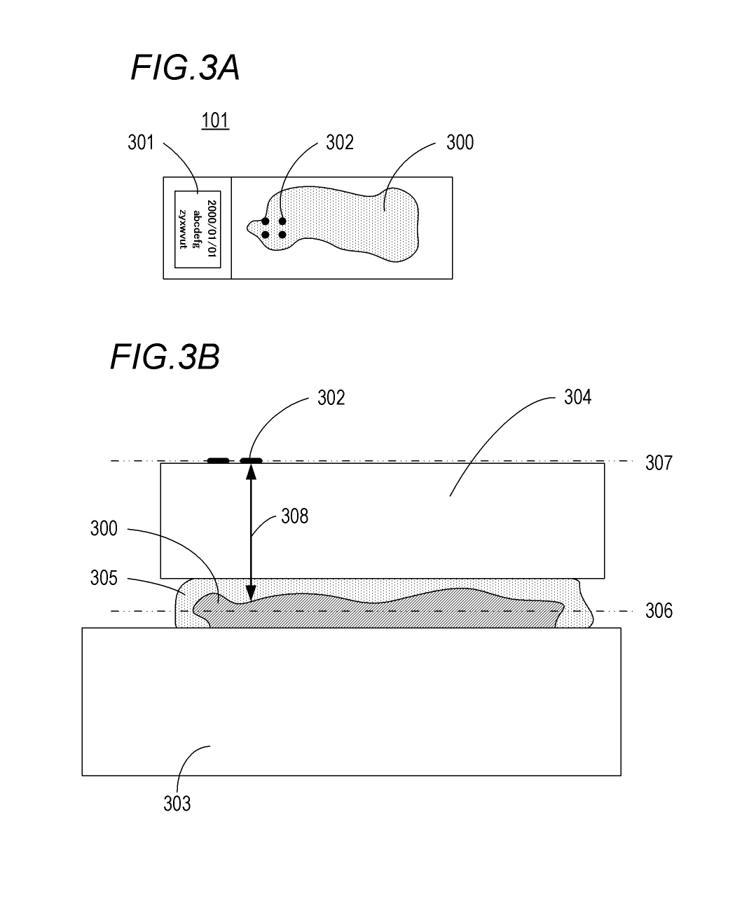

An example of the slide 101, an imaging target according to the present embodiment, is described next with reference to FIGS. 3A and 3B. FIGS. 3A and 3B each show a slide to which is fixed a specimen for diagnosis of tissue cells (referred to as “histological diagnosis,” hereinafter) used in pathological diagnosis.

FIG. 3A shows the slide 101 viewed in an observation direction. Reference numeral 300 represents a specimen, tissue cells cut into several μm in thickness. The specimen 300 is stained with a predetermined dye for the purpose of normal easy observation. Reference numeral 301 represents a label on which are written character information on the slide, a barcode indicating link information for accessing electronic data, and the like. Reference numeral 302 represents a mark that is written for easy identification of the position of a target section in an observation surface (an X-Y plane) for a future observation. The mark 302 is written by hand with a permanent marker or the like at the time of checking the specimen after the slide 101 is created or at the time of a previous examination. Note that the mark 302 may be a letter, a figure or in any other forms.

FIG. 3B shows a cross section of the slide 101 in a direction perpendicular to the observation direction. Reference numeral 303 represents a slide glass, and reference numeral 304 a cover glass. The specimen 300 is placed on the slide glass 303, and the cover glass 304 is stacked thereon with an encapsulant 305 being applied there between. The mark 302 is written on the front surface of the cover glass 304 covering the specimen 300, and is separated from the specimen 300 by a thickness 308, which is the thickness of the cover glass 304 and the thickness of the encapsulant 305 combined. Reference numeral 306 represents a Z-direction position of an in-focus surface that is obtained when the specimen 300 is focused, and reference numeral 307 a Z-direction position of an in-focus surface that is obtained when the mark 302 is focused. The objective lens of a microscope typically has a shallow depth of field. Especially a high-magnification objective lens has a depth of field that is shallower than the thickness of the cover glass 304. Therefore, when capturing an image of the specimen 300 by focusing on the Z-direction position 307, the captured image of the specimen 300 becomes off of the depth of field and becomes extremely blurry.

Thus, when the mark 302 is focused accidentally in order to capture a high magnification image of the slide 101 with the imaging unit 106 shown in FIG. 1, an unsuitable image for observation is obtained in which the specimen 300 around the mark 302 is blurry. Furthermore, in a focus determination process, when using a focus determination result of a peripheral region, there is a possibility that a wrong focus determination result of the mark 302 has an impact on the peripheral region. Focus determination according to the present embodiment described hereinafter aims to prevent capturing of an image, unsuitable for observation, which is caused by such erroneous focus determination.

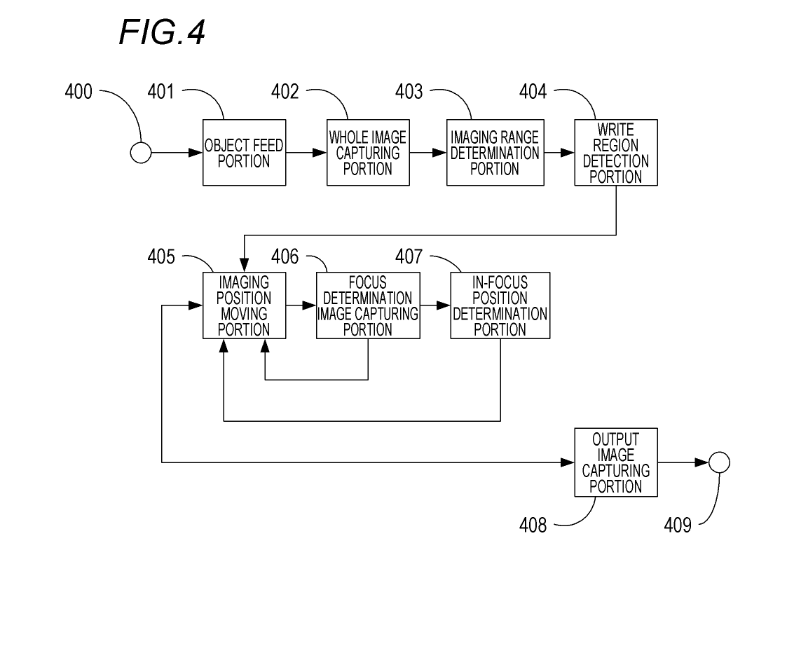

FIG. 4 is a functional block diagram of the microscopic apparatus 100 according to the present embodiment. FIG. 4 only shows the functions associated with the focus determination method out of the functions of the microscopic apparatus 100. Reference numeral 400 represents an input terminal to which an imaging operation start instruction is input. When an operation start instruction is input from the imaging operation start instruction input terminal 400, an object feed portion 401 controls the stage 107 to carry the slide 101 to a position where imaging can be performed by the whole image capturing unit 102. A whole image capturing portion 402 controls the whole image capturing unit 102 to capture an image of the entire slide 101 or of the entire region in the slide in which the specimen 300 is likely to exist, thereby capturing a whole image. The region in which the specimen 300 is likely to exist means, for example, a region other than the label 301 in the slide 101. From the obtained whole image, an imaging range determination portion 403 detects a range in which the specimen 300 actually exists, and determines an imaging range for capturing an output image. A write region detection portion 404 analyzes the whole image to detect a region that includes the written mark 302. Note that the order of the process by the imaging range determination portion 403 and the process by the write region detection portion 404 may be reversed, or these processes may be executed in parallel.

When capturing an output image using the objective lens 105 of narrow angle of view and shallow depth of field, an imaging position moving portion 405 controls the stage 107 to move the slide 101 within the X-Y plane or in the Z direction with respect to the imaging unit 106. Not only may the slide 101 be moved within the X-Y plane or in the Z direction, but also the imaging unit 106 may be moved likewise.

A focus determination image capturing portion 406 controls the imaging unit 106 to capture a focus determination image to be used to determine whether the specimen 300 in the slide 101 is focused or not. In the present embodiment, the in-focus position of the specimen 300 is determined by using a plurality of focus determination images that are captured by focusing on different Z-direction positions. Since the in-focus position is usually determined from a plurality of images captured in a plurality of Z-direction positions, imaging is executed in all the necessary Z-direction positions. Thus, imaging is executed on all the necessary Z-direction positions by repeating the Z-direction position moving process of the imaging position moving portion 405 and the imaging process of the focus determination image capturing portion 406. An in-focus position determination portion 407 uses the focus determination images to determine a Z-direction position in which the specimen 300 is in focus. Once the in-focus position determination portion 407 determines the Z-direction position in which final imaging is executed, the imaging position moving portion 405 moves the imaging position to the determined Z-direction position.

In the present embodiment, the focus determination image capturing portion 406 acquires a focus determination image by using the imaging unit 106 for capturing an output image. However, an imaging unit different from the imaging unit 106 or an optical system may be added to the configuration shown in FIG. 1 in order to acquire focus determination images.

An output image capturing portion 408 controls the imaging unit 106 to acquire an output image by capturing an image of the slide 101 using the objective lens 105 in the Z-direction position in which the specimen 300 is determined to be in focus. In a case where an unimaged region exists in the imaging range determined by the imaging range determination portion 403, the imaging position moving portion 405 is caused to move slide in the position within the X-Y plane, to execute imaging again. Reference numeral 409 is an image output terminal for outputting the output images captured by the output image capturing portion 408.

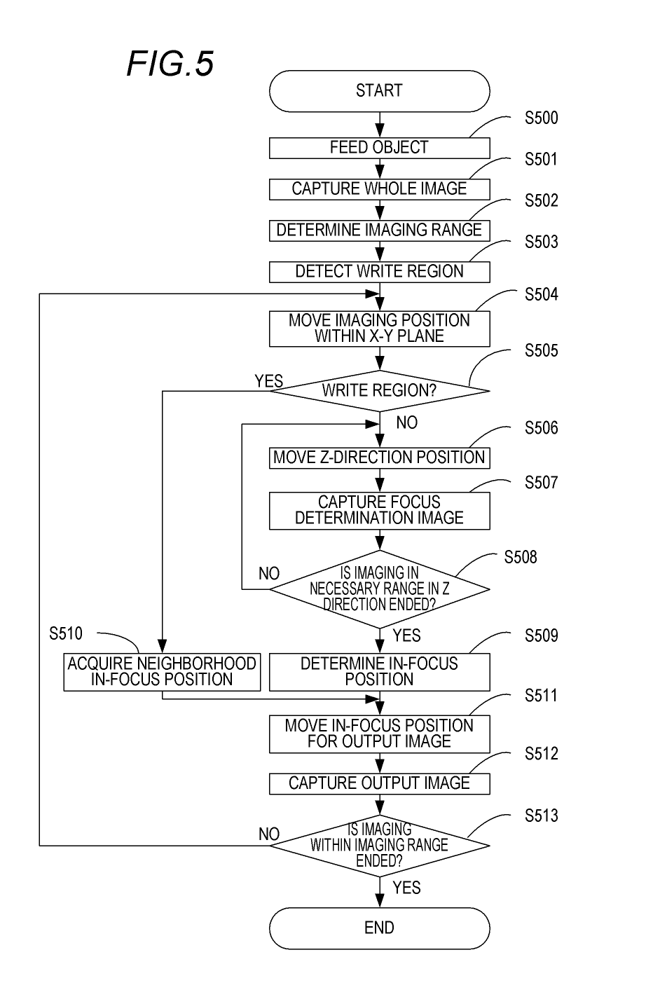

FIG. 5 is a flowchart showing a flow of operations of the focus determination method and an imaging method according to the present embodiment. As soon as a process is started, first, the object feed portion 401 feeds the slide 101, an object, in step 500. After the whole image capturing portion 402 captures a whole image of the slide 101 in step 501, in step 502, the imaging range determination portion 403 determines, from the abovementioned whole image, an imaging range of an output image within the X-Y plane. The imaging range typically has a field of view wider than that of the objective lens 105, and single imaging is not enough to obtain an output image. For these reasons, split imaging needs to be performed in which the imaging range is divided into a plurality of blocks. In step 502, therefore, an imaging position within the X-Y plane of each block is determined as well. In step 503, the write region detection portion 404 detects a write region from the whole image. Note that the order of the processes of steps 502 and 503 may be reversed, or the processes of steps 502 and 503 may be executed in parallel.

Once the imaging range for an output image and the write region are determined, in step 504 the imaging position moving portion 405 moves the slide 101 within the X-Y plane, to position the slide 101 in the original imaging position. In step 505, the in-focus position determination portion 407 determines whether the current imaging position is a write region or not, based on information on the current position within the X-Y plane and on the write region detected in step 503.

When it is determined in step 505 that the current imaging position is not a write region, an in-focus position with respect to the current imaging position is determined by an automatic focus detection using the captured image of the slide 101. Specifically, in step 506, the imaging position moving portion 405 matches the Z-direction position of the slide 101 with the initial focusing point position. Then in step 507, the focus determination image capturing portion 406 captures images of focus determination images. A plurality of focus determination images focusing on different Z-direction positions are used in focus determination. Then, step 508 determines whether imaging of a necessary range in the Z direction is ended or not. When the imaging is not ended, the process is returned to step 506 to repeat the movement and imaging of the Z-direction position. A Z-direction range for acquiring the focus determination images is determined in such a manner that it contains at least the entire region of the specimen 300 in the thickness direction (depth direction) thereof. For example, when the thicknesses of the slide glass, the specimen, the cover glass and the like can be assumed beforehand, the upper surface of the slide glass may be placed at the lowest position of the Z-direction range and the upper surface of the cover glass at the highest position. Alternatively, the levels of the upper surfaces of the slide glass and cover glass can be measured by a distance sensor or surface profile (profile), and the Z-direction range can be determined based on the obtained measurement results. Note that the interval between the Z-direction positions in the images (Z interval) may be set to be approximately equal to the depth of field.

When it is determined in step 508 that the necessary imaging is ended, the in-focus position determination portion 407 detects an in-focus position in step 509. The in-focus position determination portion 407, for example, evaluates how much the images captured in the plurality of Z-direction positions are in focus, by means of the known methods such as edge detection, contrast detection, frequency component analysis and the like, and determines the Z-direction position of the image that is in focus the most as an in-focus position. The method for determining an in-focus position is not limited to the methods mentioned above; thus, other methods may be employed.

When, on the other hand, it is determined in step 505 that the current imaging position is a write region, the process is moved to step 510. The in-focus position determination unit 407 acquires an in-focus position of a neighborhood region without detecting an in-focus position of the current position within the X-Y plane, and sets the Z-direction position of the neighborhood region as the in-focus position of the current imaging position within the X-Y plane. In other words, for an imaging position that is determined to have a mark or the like, the automatic focus detection process is not executed on the object, but an in-focus position of the current imaging position is determined using a value of an in-focus position corresponding to a position different from the current imaging position. This step employs the fact that the specimen is spread across the horizontal direction (within the X-Y plane) on approximately the same level (Z-direction position). For instance, the same value as that of the in-focus position of the nearest imaging position may be applied to the current imaging position, or a value (average value or the like) obtained from the in-focus positions of a plurality of neighborhood imaging positions (both sides/above, below, left, and right/8 neighbors, etc.) may be applied to the current imaging position. Furthermore, Z-direction in-focus positions may be acquired beforehand with respect to a plurality of points placed discretely (sparsely) (referred to as “discrete points”) on the X-Y plane of the object, and then a Z-direction position that can be estimated from the in-focus positions of these discrete points may be set as the in-focus position of the current imaging position (X-Y plane position). The method described in US 2004/0105000, for example, may be employed. Specifically, based on the values of in-focus positions of previously acquired plurality of discrete points, a two-dimensional plane, a three-dimensional plane, or a curved surface that shows a distribution of the in-focus positions is calculated by means of a linear or high-order interpolation, and then the in-focus position of the current imaging position is obtained from the calculated plane or curved surface. The plane or curved surface that shows a distribution of the in-focus positions is called “in-focus position map.”

Once the in-focus position is determined in step 509 or the in-focus position is set in step 510, the imaging position moving portion 405 moves the Z-direction position of the slide 101 to this in-focus position in step 511. Following the positioning of the slide 101, in step 512 the output image capturing portion 408 captures an image of the slide 101 to acquire an output image. The output image is an image used for observation or diagnosis on a screen called “virtual slide,” and is of higher magnification and higher resolution than those of the whole image. Only an output image of the in-focus position may be produced, or a plurality of layers of output images with different in-focus positions may be produced from a predetermined Z-direction range centering around the in-focus position.

Step 513 determines whether imaging of the entire region of the imaging range (all the imaging positions) determined in step 502 is ended or not. When imaging is not ended, the process is returned to step 504 in order to repeat the steps. When it is determined in step 513 that imaging is ended, the process is ended.

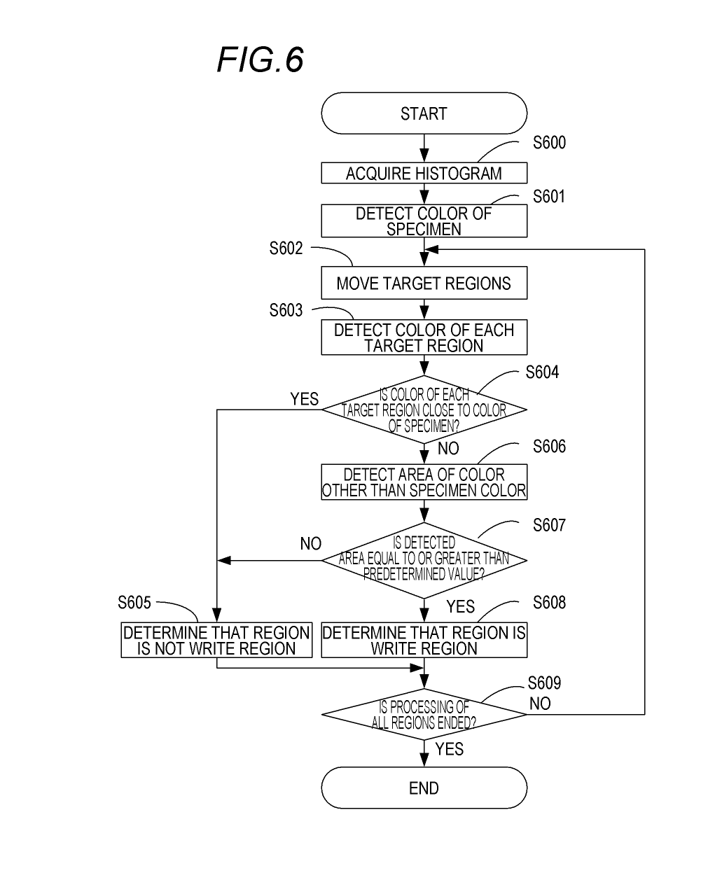

Next, an example of a detailed flow of the write region detection process of step 503 is described with reference to FIG. 6. Once this process is started, in step 600 the write region detection portion 404 acquires a histogram from the whole image. From the histogram, the write region detection portion 404 detects a color that appears most frequently as the color of the specimen 300 (e.g., the color used for staining the specimen 300) in step 601.

The subsequent process divides the whole image into a plurality of investigation regions (subregions) and determines whether each of the investigation regions is a write region or not. Specifically, in a case where any of the investigation regions includes a feature region in which an image feature related to a color satisfies a predetermined condition and this feature region covers a predetermined area or more of the whole image, the investigation region is determined as a write region. In so doing, the size of each investigation region and how to divide the whole image may be determined such that each investigation region and each of the blocks obtained through split imaging illustrated in FIG. 5 correspond to each other one-on-one. In addition, within the whole image, an investigation region outside the imaging range that is determined in step 502 of FIG. 5 may not be taken into consideration when determining whether it is a write region or not.

In step 602, the write region detection portion 404 selects an investigation region for the first process as a target region. In the next step 603, the write region detection portion 404 detects a representative color (color feature) of the target region. For example, of the colors included in the target region, a color that has a frequency of appearance equal to or greater than a predetermined value can be used as the representative color. In step 604, the write region detection portion 404 determines whether the representative color of the target region is similar to the color of the specimen 300 detected in step 601. In other words, step 604 determines whether the target region is configured by the specimen 300 alone or includes an image component other than the specimen 300.

When it is determined in step 604 that the representative color of the target region is close to the color of the specimen 300 or, in other words, that the target region is configured by the specimen 300 alone, the write region detection portion 404 determines that the target region is not a write region (step 605). Whether the representative color of the target region is close to the color of specimen 300 or, in other words, whether the similarity ratio between the two colors is equal to or greater than a predetermined value, can be evaluated by determining whether the difference between the two colors (the distance therebetween within a color space or in a chromaticity diagram) is equal to or less than a predetermined value. When evaluating the similarity ratio, only the difference in image densities (brightness) or the difference in hues may be evaluated.

When, on the other hand, it is determined in step 604 that the representative color of the target region is not close to the color of the specimen 300 (the similarity ratio is lower than the predetermined value) or, in other words, that the target region includes an image component other than the specimen 300, the process is moved to step 606. In step 606, the write region detection portion 404 detects the area (e.g., the number of pixels) of a range in which the representative color is distributed continuously (feature region), the representative color being determined as a color other than the color of the specimen 300. Since there is a possibility that the range with a continuous distribution of the representative color not only extends within the target region but also reaches an investigation region in the vicinity of the target region, the determination process of step 606 may detect the area of the feature region, including the investigation region in the vicinity of the target region. More specifically, for example, the process may binarize the target region except for the pixels of the same color as the representative color (in view of the variations of the colors, the pixels of a color similar to the representative color may be included), and thereafter count the number of continuous white pixels.

Subsequently, in step 607 the write region detection portion 404 determines whether the area of the feature region detected in step 606 is equal to or greater than a predetermined value. In a case where the area is less than the predetermined value, the write region detection portion 404 determines that the target region is not a write region (step 605). However, when it is determined in step 607 that the area is equal to or greater than the predetermined value, the write region detection portion 404 determines that the target region includes a write region (step 608). When it is determined in step 604 that there exist a plurality of the representative colors other than the color of the specimen 300, the processes of steps 606 and 607 are carried out for each of the colors. Then, when it is determined in step 607 that at least one color has an area equal to or greater than the predetermined value, the process is moved to step 608.

Once the process of step 605 or 608 is ended, the write region detection portion 404 determines whether processing of all the investigation regions is ended or not. In a case where an unprocessed region exists, the process is moved to step 602 in order to repeat the steps. However, when it is determined in step 609 that there are no unprocessed regions, the process is ended.

In the present embodiment, although a region that has a color feature not similar to the color of the specimen 300 is extracted as a write region candidate, various colors can be used as the color feature. For instance, pixel values of a color space such as RGB, the values of brightness (luminance) and color differences in a color space such as YCbCr, YPbPr, YUV, or L*a*b*, or chromaticity coordinates such as XYZ may be employed. Image features other than the color features can be employed as well. For example, in a case where the specimen 300 is a transparent matter, the average image density of the specimen 300 is lower than that of the mark 302. This enables a distinction between the specimen 300 and the mark 302 based on the image features such as image density values (brightness values). Alternatively, since a clear edge is formed at the boundary of the specimen 300 and the mark 302, a write region candidate can be extracted based on the image features such as the contrast and uniformity of the colors or image densities. Note that the depth or tinge of the stained specimen 300 or the mark 302 varies from location to location, depending on how the specimen 300 is stained or how the mark 302 is written. For this reason, when extracting a write region candidate in steps 604 and 605, it is preferred that a certain level of fluctuations in the image features be taken into consideration. For example, the difference between the color of the specimen 300 or mark 302 and the representative color is lower than the predetermined value, the colors may be regarded as identical.

The relationship between a state of an image and the contents of the processes according to the present embodiment is described next.

The region that is imaged as the whole image is likely to include the specimen 300 as shown in FIG. 3A. If a region with the label 301 cannot be specified prior to imaging, an image of the entire slide 101 may be captured, and thereafter the label 301 may be detected from the captured imaged, and then the region outside the label 301 may be regarded as the region that is likely to include the specimen 300. Then, the region that is likely to include the specimen 300 is subjected to the process of step 502 shown in FIG. 5, to detect a region that actually includes the specimen 300 (referred to as “specimen range,” hereinafter).

As described with reference to FIG. 3A, since the mark 302 is written in the vicinity of a region in the specimen 300 that needs attention, the detected specimen range includes the written mark 302 as well. Because writing is performed only on part of the entire slide, the area of the mark 302 in the entire image is much smaller than the area of the specimen range. Therefore, when a histogram of the whole image or the specimen range is acquired, the pixel values corresponding to the color of the specimen 300 appear more frequently. On the other hand, the frequency of the pixel values corresponding to the color of the mark 302 is lower than that of the color of the specimen 300. Moreover, although individual cells of the specimen 300 cannot be confirmed at an optical magnification for capturing the whole image, the mark 302 is large enough to visually see and therefore has a region of a predetermined area in the whole image. Since a permanent marker used is typically approximately at least 0.3 mm in thickness, even when production variation or variation in writing of the mark 302 is taken into consideration, an image component that contains a line or dot having a thickness or diameter of approximately 0.1 mm or more is written. Therefore, the mark 302 within the specimen range can be detected with a high degree of accuracy through evaluation under the condition that the region has an image feature that is different from the image feature that appears at high frequency in the whole image (the image feature of the specimen), and has an area equal to or greater than a predetermined value.

If the focus determination process is executed in the region containing the mark 302, it cannot be denied that the mark 302 is focused instead of the specimen 300. This leads to a decrease in credibility of the result of the focus determination. Especially because the angle of view (field of view) of a microscope is typically smaller than that of an object, when capturing an image of the entire object, split imaging needs to be performed in which images of subregions of the object are captured using an area sensor, or an image of the object is captured by running a line sensor to scan the object. In so doing, in order to simplify the focus determination process at the time of imaging, focus determination is executed in view of a focus determination result of a neighboring region by taking advantage of the fact that the specimen 300 is a continuous matter. In this case, when the mark 302 is present in the neighboring region to be referenced, and the mark 302 is focused, the result of erroneous focus determination has an impact on the surrounding regions, resulting in a failure to focus over a wide range. In the present embodiment, instead of executing the focus determination process on the region including the mark 302, the in-focus position detected in an adjacent peripheral region is used. This can prevent erroneous focus determination that is caused when using an image of the region including the mark 302. In addition, according to the present embodiment, a region with the mark 302 written therein is detected prior to the time-consuming focus determination process that requires multiple imaging processes, so this region does not have to be subjected to the focus determination process. As a result, the time it takes to perform focus determination on the entire imaging range can be reduced, increasing the processing speed.

Note that the present invention is not limited to the foregoing configurations.

For example, although step 601 shown in FIG. 6 acquires the color information of the specimen 300 by using the histogram of the whole image, the color of the specimen 300 may be estimated by means of a different image processing method. Alternatively, the color information of the specimen 300 may be obtained by acquiring the information on staining that is performed to prepare the slide 101 as relevant information on the slide 101. Furthermore, in a case where the whole image of the slide 101 is captured using a device different from the microscopic apparatus 100, the color information on the dye or specimen may be retained as the relevant information along with the whole image, and then the relevant information may be read at the time when the microscopic apparatus 100 reads the whole image.

In addition, although FIGS. 4 and 5 illustrate the examples in which the focus determination images and output images are captured separately, these images may be identical. In this case, the focus determination image capturing portion 406 may capture an output image, and the output image capturing portion 408 may extract and output only an image in focus.

Moreover, a modification can be employed in which step 505 for determining whether the imaging position is a write region or not may be executed subsequent to step 508, and when the imaging position is a write region, step 509 may be skipped.

Furthermore, the present embodiment has described the example in which an in-focus position is determined using images obtained at a plurality of Z-direction positions. However, the focus determination method is not limited thereto; thus, the present embodiment is applicable to another focus determination method that is likely to cause erroneous focus determination due to the mark 302 written on the object.

When observing a transparent matter, the light from the light source is observed as-is in a region that does not have the specimen 300, and is detected as a pixel value of a color close to extremely bright white. In some cases the region that does not have the specimen is much larger than the cells contained in the specimen 300, as with the mark 302. Therefore, a process for determining that such a region is not the mark 302 and excluding it may be additionally executed. Note that, in some cases, the color of the light source is not pure white but has a tinge of, for example, yellow. Thus, information on the light source used for imaging or information on a color filter may be acquired separately, and when it is determined that the region is the color of the light source, the region may be excluded.

### Second Embodiment

The first embodiment has described the example of detecting the mark 302 using a whole image so that focus determination is not executed on the position of the mark 302. However, when the resolution of the whole image capturing unit 102 for capturing a whole image is low, and when the mark 302 is small, the mark 302 on the whole image might not be able to be detected easily. The second embodiment describes an example of detecting the mark 302 by using a focus determination image or output image that is obtained by capturing a local image using a high-magnification objective lens, instead of a whole image.

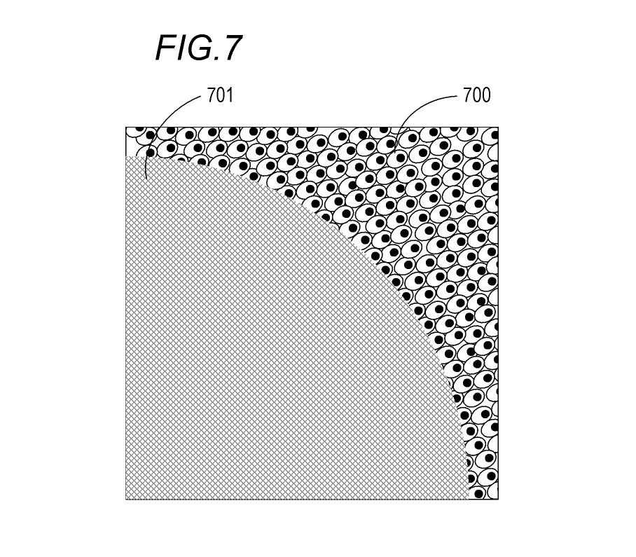

FIG. 7 shows an example of a state of a target region. In FIG. 7, reference numeral 700 represents a specimen region, a part of the specimen 300. Reference numeral 701 represents a mark region, a part of the written mark 302. In case of a focus determination image or output image, when an image of the specimen region 700 configured by a plurality of cells is captured at a Z-direction position where the specimen 300 is in focus, the individual cells can be confirmed, as shown in FIG. 7. However, when an image of the specimen region 700 is captured at a Z-direction position where the specimen 300 is out of focus, the image within the specimen region 700 becomes extremely blurry due to the shallow depth of field of the objective lens 105. As a result, the specimen region 700 is observed as a region having a substantially uniform color (mixed with the color of the stained specimen).

As with the region of the specimen 300 in the whole image described in the first embodiment, the color of the dye used for staining the specimen makes up the majority of the specimen region 700. For example, a large number of pixel values corresponding to the color of the dye are detected in the specimen region 700 of the side 101. In the mark region 701, on the other hand, the mark is written with a pen such as a permanent marker. When determining a pixel value in the mark region 701, a pixel value corresponding to the ink of the pen is obtained.

In some cases the color appearing in the specimen region 700 is close to the color appearing in the mark region 701. Typically, for example, two types of dyes are used in HE staining which is the most popular technique in histological diagnosis. In HE staining, eosin is used to stain the cytoplasm of the specimen 300 in reddish purple, and hematoxylin is used to stain the nuclei of the specimen 300 in bluish purple. Since the cross-sectional area of cytoplasm is typically larger than that of nuclei, the specimen 300 appears in reddish purple when observed at a low magnification or observed out of focus. However, when the specimen 300 is in focus, the shape and color of the dark, bluish purple nuclei can clearly be observed as well as the cytoplasm. Furthermore, depending on the concentration of the hematoxylin in the stain solution or the length of time spent staining a specimen, in some cases the specimen is stain in a darker color, such as black or blue, resembling the color of the ink of a permanent marker.

As in the focus determination images or output images, in some cases a pixel value that is close to that of the mark 302 is detected as a result of high-magnification observation, depending on the in-focus state. However, because the mark 302 is drawn with a marker, the tip end of which is much thicker than the size of the cells to be observed, it is only necessary to determine the color and at the same time detect a region that has the area much wider than the size of the cells.

Note that the focus determination images have different in-focus positions as a result of being imaged at a plurality of Z-direction positions. Thus, the specimen 300 and the mark 302 appear differently. In a case where any one of these focus determination images imaged in a plurality of Z-direction positions has a region with a trait of writing, this region may be determined as a write region. This can improve the accuracy of determining a write region.

Note that, even when the whole image capturing unit 102 has low resolution, a histogram of the color of the specimen 300 can be extracted from an obtained whole image. Therefore, as in the first embodiment, the color of the specimen (the color of the dye) may be obtained based on the histogram that is acquired beforehand from the whole image. Then, a mark region may be detected by comparing the colors and areas in the focus determination images or output images, which are local images.

Favorable examples of a color acquisition method according to the present embodiment include a method for acquiring, apart from the images, stain information as relevant information and then specifying the color appearing in the specimen region 700 based on the relevant information. Especially when a plurality of dyes are used, as in HE staining described above, the number of colors observed from the specimen 300 varies, depending on the in-focus state, as described above. In such a case, when the colors used are estimated based on histograms acquired from an obtained whole image, the color of the dye used to stain the nuclei with a small area might not be detected. By acquiring stain information apart from the images, even a color component that cannot be detected through a histogram calculation can be detected.

Especially in a case where the capturing a whole image (step 501 in FIG. 5) is not executed at all, a write region may be detected using the focus determination images or output images. In such a case, it is difficult to obtain a histogram of the entire specimen 300. However, the necessity to obtain a whole image can be eliminated by separately acquiring the stain information.

In the present embodiment, the presence/absence of the mark 302 is determined using the local focus determination images or output images. The subsequent processes may be the same as those described in the first embodiment. In other words, when the current imaging position set in step 504 of FIG. 5 is determined as a write region, focus determination (step 509) is not performed on this imaging position, but an in-focus position of a peripheral region is used, or an in-focus position of the imaging position is estimated from in-focus positions of a plurality of discrete points that are acquired beforehand (step 510). In a case where the current imaging position determined as a write region, the focus determination processes illustrated in steps 506 to 509 may be executed on this imaging position.

In the present embodiment the focus determination images and the output images are treated as different images; however, the step of capturing the output images may be omitted by capturing the focus determination images under the same conditions as those required for obtaining the output images. In this case, since the images for focus determination are already obtained in the plurality of Z-direction positions, the focus determination images corresponding to the in-focus positions may be extracted and output as output images.

According to the present embodiment, the mark 302 can be detected using the focus determination images or output images instead of using a whole image, as described above. Since the necessity to determine the mark 302 on a whole image is no longer necessary, the mark 302 can be detected with a high degree of accuracy even when the resolution of the whole image is low.

Consequently, highly accurate focus determination can be executed while avoiding the location of the mark 302. So long as the imaging system or process for a whole image can be omitted, downsizing of the apparatus and high-speed processes can be achieved.

### Third Embodiment

The first and second embodiments have described the examples of detecting the mark 302 based on a combination of a color and an area in an image. A third embodiment describes an example of detecting the mark 302 based on the features other than colors and controlling focus determination.

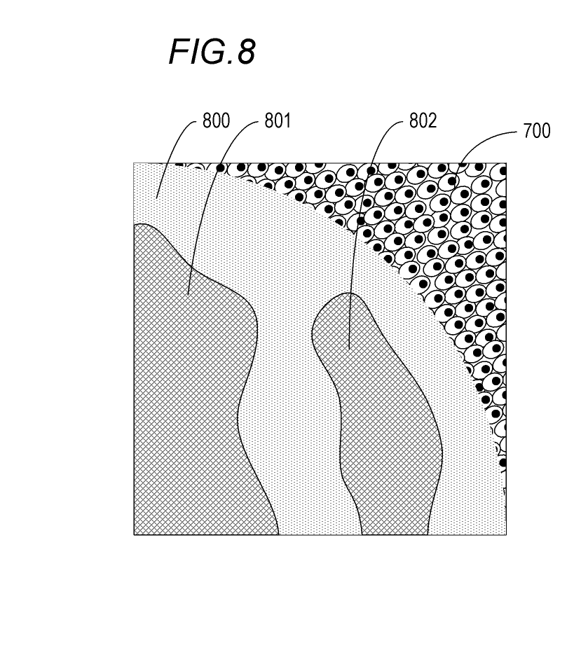

FIG. 8 shows another example of a state of a target region. The example shown in FIG. 7 has described that the region 700 with the written mark 302 has a specific color (within a predetermined range). However, depending on how the mark 302 is written, there is a possibility that the image densities fluctuate so significantly that it becomes difficult to identify that the color is uniform. In FIG. 8, reference numeral 800 represents a region of the mark 302 that has low image density, and reference numerals 801 and 802 regions with high image densities. The image density fluctuation shown in FIG. 8 occurs in a situation where a mark is formed into a size larger than the thickness of a marker. A mark with small image density non-uniformity as shown in FIG. 7 can be obtained by bringing the tip end of a marker into contact with a portion to be written and then releasing the tip end without moving. However, when the tip end of the marker is moved after being brought into contact with the portion to be written, the tip end of the marker is moved while pushing aside the ink thereof attached to the tip end, and consequently the ink fades along the trace of the tip end, resulting in the low image density region 800. In a region surrounding the trace of the tip end of the marker, on the other hand, the ink that is pushed aside is swept, creating pools of ink, hence the high image density regions 801 and 802. This sometimes creates a significant difference in image density between the low image density region 800 and the high image density regions 801, 802, making it difficult to identify at a glance that the colors thereof are identical. Especially when the specimen 300 placed underneath can be seen through, in some cases the image density becomes low in the low image density region 800. The present embodiment describes an example in which the mark 302 can be detected even in such a case described above.

A method described in the present embodiment is particularly effective when applied to an image in which the image densities of the mark 302 fluctuate or an image in which the cells included in the specimen region 700 can be observed. In other words, the method is particularly effective in detecting the mark 302 by using focus determination images or output images.

Features of an image obtained by imaging and a process for detecting the mark 302 based on the features of the image are now described hereinafter.

In FIG. 8, when the low image density region 800 and the high image density regions 801, 802 are formed by the movements of the tip end of a marker, the surface tension of the ink acts in the vicinity of the borderline of each region, whereby the fluctuations of the ink concentration becomes moderate, making it difficult to form a clear edge. On the other hand, a clear edge is present between the region 800, 801, 802 where the ink is present and the specimen region 700 where the ink is absent. Furthermore, especially at a high imaging magnification, a number of edges are detected in the specimen region 700 due to the dense cells therein.

Therefore, the mark 302 can be detected by using an image feature related to the smooth image density changes in place of the image features described above that are related to the colors. In other words, if a region that has the image density changes smoother (more moderate) than a predetermined condition has an area equal to or greater than a predetermined value, this region is determined as the written mark 302. As a method for detecting an image feature related to the smoothness, various known methods using, for example, an edge enhancement (or extraction) filter such as a differential filter or frequency analysis can be employed. In case of an edge enhancement (or extraction) filter, if a computation result is smaller than a predetermined threshold, the image density changes can be determined to be smooth. In case of frequency analysis, if the intensity of a low-frequency component is greater than a predetermined threshold or the intensity of a high-frequency component is smaller than a predetermined threshold, the image density changes can be determined to be smooth. In addition to the image densities, the method can also be applied to see changes in brightness values, changes in color differences, and various other changes in pixel values representing images.

Sometimes there exist a region in which the cells appear to be scattered when viewed locally. In this case, an edge cannot be detected in a region between cells, and such a region is likely to be determined as a region with smooth changes in pixel values. As described in the first embodiment, the size of the mark 302 to be detected is much larger than that of the cells. For this reason, even when the color of the specimen 300 is unknown, the mark 302 can be detected with a high degree of accuracy by determining both the smoothness of the changes in pixel values and whether the area of the smooth region is equal to or greater than a predetermined value.

It is preferred that the method described in the present embodiment detect a write region by using the focus determination images or output images that are captured at a high magnification at which the features of the mark 302 can be observed. However, when the whole image has a sufficiently high resolution and the features of the mark 302 can be observed, the whole image may be used instead. The order of the processes to be executed may be changed when determining the color and the smooth region.

According to the present embodiment, the mark 302 can be detected based on the smoothness of the changes in pixel values. Thus, even when the color of the specimen 300 or the color of the dye used for staining the specimen 300 is unknown, the mark 302 can be detected by means of the smoothness of the changes in pixel values and the fact that the area of the smooth region is equal to or greater than a predetermined value.

### OTHER EMBODIMENTS

The present invention is not limited to the foregoing embodiments and may have various other embodiments.

For instance, an application example of using a combination other than the two factors described above is conceivable, the two factors being the smoothness of the changes in pixel values and the fact that the area of the smooth region is equal to or greater than a predetermined value.

In a case where the colors included in the specimen 300 are found out from the histograms or external information, there is a possibility that colors other than the colors of the specimen 300 represent the mark 302. In addition, as described above, the pixel values of the mark 302 change smoothly. Thus, a region in which the pixel values thereof change smoothly may be detected from the regions that include colors other than the colors of the specimen 300, to detect the mark 302. In this manner, the mark 302 can be detected only in, for example, a target region or in the target region and a region adjacent thereto that has a relatively narrow range. This is especially effective in detecting the mark 302 with the focus determination images or output images that have narrow angles of view with respect to the specimen 300.

Moreover, the mark 302 may be detected in view of all the foregoing features of the mark 302 or the specimen 300. Specifically, a feature region may be determined using both the image features of the colors and the image features related to the smoothness of the changes in pixel values, and when the area of the feature region is equal to or greater than a predetermined value, the feature region may be determined as the mark 302. For example, for the regions in which the image features of the colors satisfy the conditions, the conditions of the image features related to the smoothness of the changes in pixel values may be relaxed. By doing so, even when the changes in pixel values are no longer smooth in the mark 302 due to, for example, dust and dirt adhered thereto or due to scratches therein as a result of peeling of the ink, erroneous detection can be prevented. Specifically, erroneous detection can be prevented by ignoring an edge caused by dirt and damages in a region that includes a color that is highly likely to resemble the mark 302 or by changing the threshold which is the criterion for determining the smoothness.

In the foregoing embodiments, the calculated values obtained from neighborhood regions or the estimate values obtained from the in-focus positions of the plurality of discrete points were set in the imaging position that is determined as a write region. However, it is desired that the set in-focus positions be changed for the following reasons, such as when calculation from the neighborhood regions is not precise enough depending on imbalance between the structures (nuclei, etc.) of a specimen to be imaged and when estimation precision is poor due to wide spaces between the discrete points. In these cases, the most in-focus Z-direction position may be searched from the vicinity of the set in-focus positions. For example, in-focus positions are changed in order to achieve better focusing, by comparing the contrast values and other in-focus levels between an image captured with the set in-focus positions and an image captured after shifting the focusing position in the optical axis direction.

Furthermore, when using a method for calculating a plane or a curved surface based on the values of the in-focus positions of the plurality of discrete points that are spatially scattered, and when determining (selecting) a discrete point to be used to calculate the plane or curved surface, the determination result on the write region may be used. In other words, a plurality of measuring points may be placed discretely in a region of a specimen other than a subregion that is determined as a write region, and an in-focus position may be detected in each of the measuring points, and then a plane or a curved surface that shows a distribution of the in-focus positions may be calculated based on the detection result. This plane or curved surface (in-focus position map) can be used to estimate an in-focus position of an imaging position (X-Y plane position) other than the measuring points.

The foregoing embodiments have described that the microscopic apparatus of the present invention is realized by programs executed by the CPU 200; however, the present invention is not limited to these embodiments. For example, all or part of the embodiments may be implemented by hardware.

As described above, use of the present invention serve to prevent a mark on a specimen from being focused by mistake when executing focus determination at the time of imaging. Therefore, imaging focusing on a specimen can be performed.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-053655, filed on Mar. 17, 2014, and Japanese Patent Application No. 2014-260918, filed on Dec. 24, 2014, which are hereby incorporated by reference herein in their entirety.

What is claimed is:

1. A focus determination method for determining an in-focus position in an optical axis direction at each of imaging positions when performing split imaging of an object using a microscope, the focus determination method comprising:
a write region detection step of detecting a write region in which writing is performed on the object, based on an image obtained by imaging the object; and
an in-focus position determination step of determining an in-focus position of each of the imaging positions,
wherein when a certain region includes a feature region that is a region in which an image feature related to a color or an image feature related to smoothness of a change in a pixel value satisfies a predetermined condition, and when the feature region has an area equal to or greater than a predetermined value in the image, the region is determined to be a write region in the write region detection step, and
for an imaging position within the write region, an in-focus position of the imaging position is determined based on a value of an in-focus position of a position different from the imaging position, in the in-focus position determination step.

2. The focus determination method according to claim 1, wherein, for an imaging position outside the write region, an in-focus position is determined by executing an automatic focus detection process for detecting an in-focus position of the imaging position, in the in-focus position determination step.

3. The focus determination method according to claim 1, wherein, for an imaging position within the write region, an in-focus position of the imaging position is determined based on a value of an in-focus position of a position different from the imaging position without executing an automatic focus detection process for detecting an in-focus position, in the in-focus position determination step.

4. The focus determination method according to claim 1, wherein, for an imaging position within the write region, a value same as that of an in-focus position of a nearest imaging position or a value obtained from in-focus positions of a plurality of neighborhood imaging positions is applied to an in-focus position of the imaging position, in the in-focus position determination step.

5. The focus determination method according to claim 1, wherein, for an imaging position within the write region, an estimate value of the imaging position is obtained from values of in-focus positions of a plurality of discrete points placed discretely on the object and the estimate value is applied to an in-focus position of the imaging position, in the in-focus position determination step.

6. The focus determination method according to claim 1, wherein whether a subregion corresponding to each of the imaging positions is the write region or not is determined in the write region detection step.

7. The focus determination method according to claim 2, wherein the automatic focus detection process is a process for acquiring a plurality of focus determination images by imaging the object while changing a focusing position in the optical axis direction, evaluating an in-focus level of each of the plurality of focus determination images, and determining a focusing position in which a focus determination image of the highest in-focus level is obtained, as an in-focus position.

8. The focus determination method according to claim 1, wherein, in the write region detection step, a color of the highest frequency of appearance is detected from an image obtained by imaging the object, and a region that has a color of which similarity ratio to the detected color is lower than a predetermined value is determined as the feature region.

9. The focus determination method according to claim 1, wherein, in the write region detection step, information indicating a color of the object is acquired as relevant information of the object or relevant information of an image obtained by imaging the object, and a region that has a color of which similarity ratio to the color of the object is lower than a predetermined value is determined as the feature region, the color of the object being obtained as the relevant information.

10. The focus determination method according to claim 1, wherein the image feature related to a color is a pixel value, a brightness/color difference value, a chromaticity coordinate, an image density value, or a contrast.

11. The focus determination method according to claim 1, wherein, in the write region detection step, when determining whether a region is a feature region or not, a condition for the image feature related to smoothness of a change in a pixel value is relaxed in a region in which the image feature related to a color satisfies a predetermined condition.

12. The focus determination method according to claim 1, wherein
the object is a slide to which a specimen is fixed, and
the writing is a mark that is written on a front surface of a cover glass covering the specimen.

13. The focus determination method according to claim 1, wherein an image obtained by imaging the object is a whole image of a slide, an image of a region in the slide in which a specimen is likely to exist, or an image that is used in an automatic focus detection process for detecting an in-focus position.

14. A focus determination apparatus for determining an in-focus position in an optical axis direction at each of imaging positions when performing split imaging of an object using a microscope, the focus determination apparatus comprising:
a write region detection portion configured to detect a write region in which writing is performed on the object, based on an image obtained by imaging the object; and
an in-focus position determination portion configured to determine an in-focus position of each of the imaging positions,
wherein when a certain region includes a feature region that is a region in which an image feature related to a color or an image feature related to smoothness of a change in a pixel value satisfies a predetermined condition, and when the feature region has an area equal to or greater than a predetermined value in the image, the write region detection portion determines that the region is a write region, and
for an imaging position within the write region, the in-focus position determination portion determines an in-focus position of the imaging position based on a value of an in-focus position of a position different from the imaging position.

15. An imaging apparatus having a function for performing split imaging of an object using a microscope, the imaging apparatus comprising:
the focus determination apparatus according to claim 14 which determines an in-focus position in an optical axis direction at each of imaging positions when performing split imaging of an object;
an imaging position moving portion configured to move a position of the object in the optical axis direction in accordance with the in-focus position determined by the focus determination apparatus; and
an output image capturing portion configured to acquire an output image by imaging the object that is aligned by the imaging position moving portion.

16. A non-transitory computer readable storage medium storing a program for causing a computer to execute each of the steps of the focus determination method according to claim 1.
